(19) United States
(12) Patent Application Publication
(10) Pub. No.: US 2014/0253523 A1
(43) Pub. Date: Sep. 11, 2014

(54) Electromagnetic Pointer Control Method

(71) Applicant: WALTOP INTERNATIONAL CORPORATION, Hsinchu City (TW)

(72) Inventor: Shao-Yu Li, Hsinchu City (TW)

(73) Assignee: WALTOP INTERNATIONAL CORPORATION, Hsinchu City (TW)

(21) Appl. No.: 13/974,034

(22) Filed: Aug. 22, 2013

(30) Foreign Application Priority Data
Mar. 11, 2013 (TW) 102108555

(51) Int. Cl. G06F 3/0354

(52) U.S. Cl. CPC G06F 3/03545
USPC 345/179

(57) ABSTRACT

An electromagnetic pointer control method includes the following steps. Firstly, an electromagnetic pointer is applied upon an electromagnetic input device. Then, a coordinate moving distance Lₜ of the electromagnetic pointer is calculated. The coordinate moving distance Lₜ is sampled and differentiated to obtain a coordinate displacement Iₜ. A coordinate sampling length φ is calculated by the coordinate displacement Iₜ. Next, an actual moving distance m is calculated according to φ, a unit μ of the actual moving distance, a predetermined unit transformation gain α and a coordinate resolution R. Then, m is differentiated to obtain an acceleration variation T. Next, T is integrated to obtain an integrated distance M. Finally, a tip pressure of the electromagnetic pointer pre is calculated according to M, a predetermined maximum tip pressure preₘₐₓ, a predetermined minimum tip pressure preₘᵢₙ, and a predetermined moving distance D_{M}.

### CROSS-REFERENCE TO RELATED APPLICATIONS

The entire contents of Taiwan Patent Application No. 102108555, filed on Mar. 11, 2013, from which this application claims priority, are incorporated herein by reference.

### BACKGROUND OF THE INVENTION

1. Field of the Invention

The present invention generally relates to an electromagnetic pointer control method, and more particularly to an electromagnetic pointer control method which can provide an electromagnetic pointer with a tip pressure-sensitive function.

2. Description of Related Art

The operation principle of electromagnetic type input technology is performed by a circuit board with a plurality of antennas or sensor coils arranged along axial directions and an electromagnetic pen which can emit electromagnetic signals. The sensing plane of an electromagnetic input apparatus includes a plurality of antennas or sensor coils. The antennas or sensor coils are arranged under a work surface or a display panel of the electromagnetic input apparatus. The coordinates of the electromagnetic pen are obtained through processing and calculating signals transmitted between the circuit of the electromagnetic pen and the antennas or the sensor coils.

Input apparatuses which use the electromagnetic type input technology comprise smart mobile devices (Smart Phone), digitizers or tablets or e-books/green books and are used with electromagnetic pens or styluses.

The circuit of the electromagnetic pen usually comprises an inductor, a capacitor and relative components enclosed in a case. The inductor constituted by a ferrite core winded with a metal coil and the capacitor constitute the circuit to transmit and receive electromagnetic signals with the antennas or sensor coils. The frequency of the circuit is determined according to the capacitance and the inductance connected in parallel. When a user utilizes the electromagnetic pen to perform writing function on the input apparatus, the tip of the electromagnetic pen being pressed would induce the continuous changes of the inductance or capacitance as well as the frequency of the circuit. The input apparatus detects and calculates the frequency of the electromagnetic signals received to obtain pressure gradients or levels of the electromagnetic pen via an internal circuit.

The main design principle for obtaining pressure gradient value of an electromagnetic pen mentioned above is to continuously change capacitance or inductance so as to alter the transmitting frequency of the oscillation circuit when the pen tip is pressed, so that a trigger structure connected to the pen tip which can change the capacitance or inductance must be used.

The invention focuses on an electromagnetic control method which can be used on an electromagnetic pen without a trigger structure connected to the pen tip so that any electromagnetic pen without a tip trigger structure can have a tip pressure-sensitive function.

### SUMMARY OF THE INVENTION

One object of the invention is to provide an electromagnetic pointer control method. The electromagnetic pointer control method enables users to perform various functions of an electromagnetic pointer through converting coordinate movement signals generating from writing operation of the electromagnetic pointer to tip pressure gradient value signals by firmware or software programs when the electromagnetic pointer is applied on electromagnetic input apparatus or system.

The invention provides an electromagnetic pointer control method, the method comprises the following steps. First of all, an electromagnetic pointer is applied upon an electromagnetic input device. Then, a coordinate moving distance Lₜ of the electromagnetic pointer is calculated. The coordinate moving distance Lₜ is sampled and differentiated to obtain a coordinate displacement Iₜ. A coordinate sampling length φ is calculated by the coordinate displacement Iₜ. Next, an actual moving distance m is calculated according to φ, a unit μ of the actual moving distance, a predetermined unit transformation gain α and a coordinate resolution R. Then, m is differentiated to obtain an acceleration variation T. Next, T is integrated to obtain an integrated distance M.

Finally, a tip pressure of the electromagnetic pointer pre is calculated according to M, a predetermined maximum tip pressure preₘₐₓ, a predetermined minimum tip pressure preₘᵢₙ, and a predetermined moving distance D_{M}.

### BRIEF DESCRIPTION OF THE DRAWINGS

FIG. 1 shows an electromagnetic pointer and a sensing plane of an electromagnetic input apparatus according to one embodiment of the present invention.

FIG. 2 shows an electromagnetic input apparatus according to one embodiment of the present invention.

FIG. 3 shows an input system which applies one embodiment of the invention.

FIG. 4 shows a flow chart of an electromagnetic pointer control method with a tip pressure-sensitive function according to one embodiment of the present invention.

FIG. 5 shows a schematic diagram of a coordinate movement of an electromagnetic pointer.

FIG. 6 shows a schematic diagram of sampling a coordinate moving distance of an electromagnetic pointer.

### DETAILED DESCRIPTION

Embodiment of this invention will be described in detail below. However, in addition to as described below, and this invention can be broadly implemented in the other cases the purpose and scope of this invention is not affected by the application of qualified, claim after its prevail. Furthermore, to provide a description more clear and easier to understand the invention, the pieces within the schema and not in accordance with their relative size of drawing, compared to certain dimensions to other scales have been exaggerated; details not related nor completely drawn in part in order to schematic simplicity.

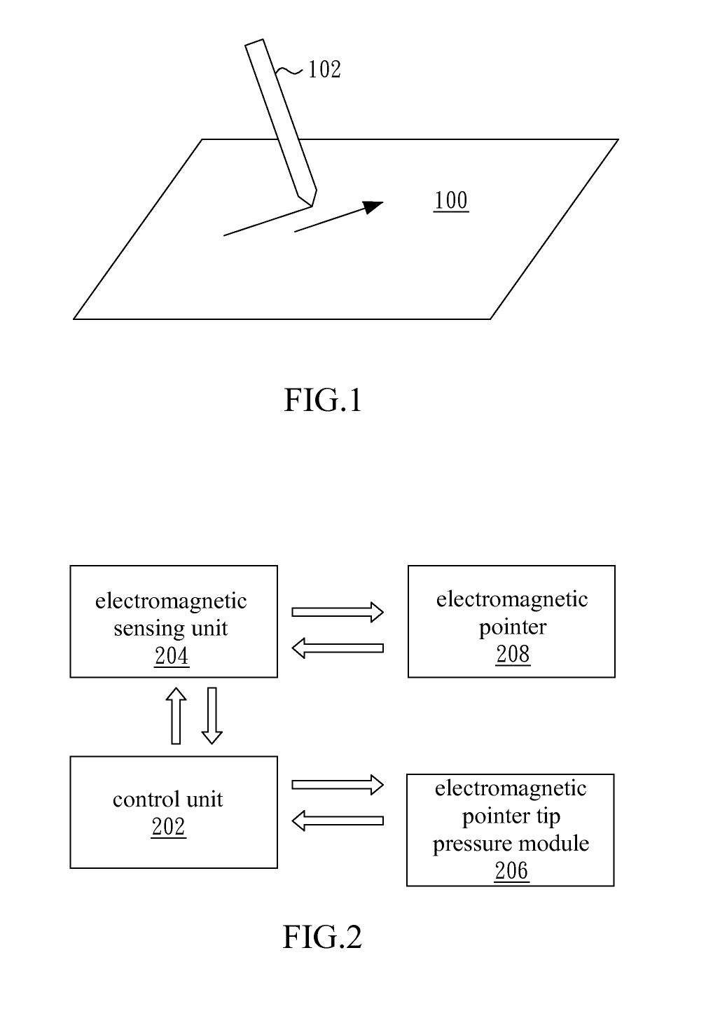

FIG. 1 shows an electromagnetic pointer and a sensing plane of an electromagnetic input apparatus according to one embodiment of the present invention. As shown in FIG. 1, the electromagnetic pointer 102 is applied to perform input operation upon the sensing plane 100 of the electromagnetic input apparatus. In one embodiment of the invention, the electromagnetic pointer 102 comprises, but not limited to an electromagnetic pointer without a trigger structure connected to the pen tip for performing a tip pressure-sensitive function. The electromagnetic pointer is merely an example of one embodiment of the invention, not a limitation. The embodiment of the invention is able to be applied any other suitable electromagnetic pointer.

FIG. 2 shows an electromagnetic input apparatus according to one embodiment of the present invention. In one embodiment of the invention, the electromagnetic input apparatus comprises a control unit 202, an electromagnetic sensing unit 204 and an electromagnetic pointer tip pressure module 206. The electromagnetic input apparatus comprises, but not limited to a digitizer and an electromagnetic input module of a mobile communication apparatus. The electromagnetic pointer tip pressure module 206 comprises firmware programs and memory storing the firmware programs so as to perform an electromagnetic pointer control method which can provide an electromagnetic pointer 208 with a tip pressure-sensitive function when the electromagnetic pointer 208 is applied upon the sensing plane of the electromagnetic input apparatus to perform input operation. Detail content of the electromagnetic pointer control method for providing an electromagnetic pointer with a tip pressure-sensitive function will be described in the following description.

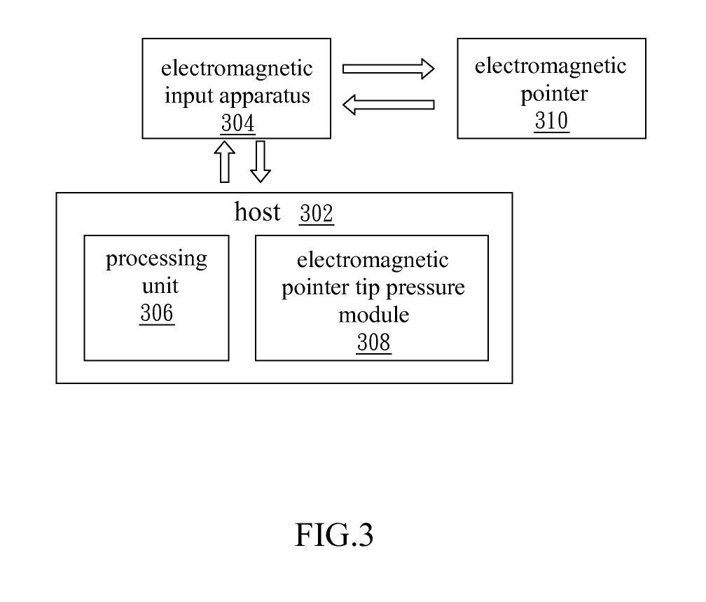

FIG. 3 shows an input system which applies one embodiment of the invention. In one embodiment of the invention, the input system comprises a host 302 and an electromagnetic input apparatus 304. The host 302 comprises, but limited to a computer and a mobile communication apparatus. The host 302 comprises a processing unit 306 and an electromagnetic pointer tip pressure module 308. The electromagnetic pointer tip pressure module 308 comprises software programs and computer readable mediums storing the software programs so as to perform an electromagnetic pointer control method which can provide an electromagnetic pointer 310 with a tip pressure-sensitive function when the electromagnetic pointer is applied upon the sensing plane of the electromagnetic input apparatus 304 to perform input operation. The computer readable medium stores executable codes or programs for the processing unit 306. The computer readable medium comprises storage mediums such as a hard drive, a memory, etc.

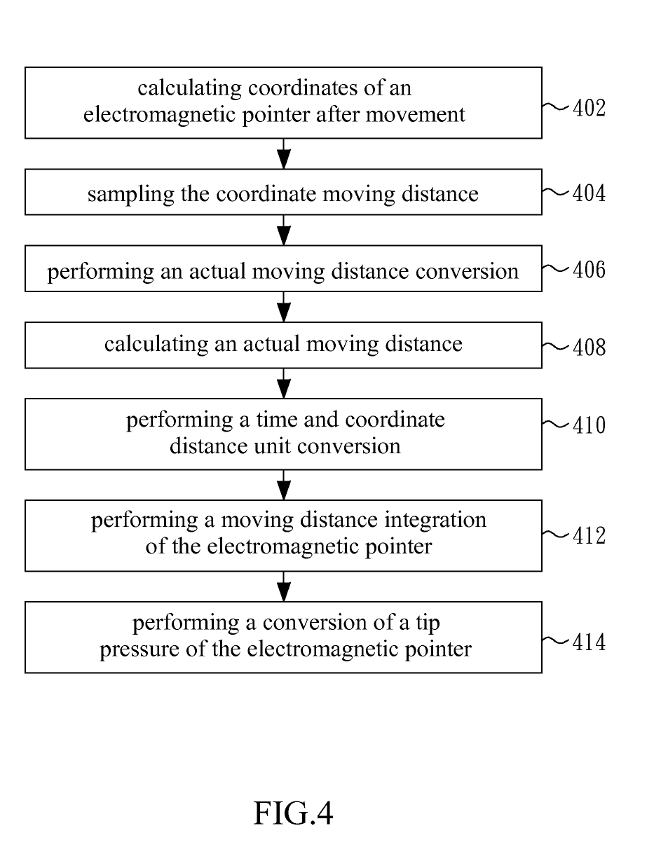

FIG. 4 a flow chart of an electromagnetic pointer control method with a tip pressure-sensitive function according to one embodiment of the present invention. In one embodiment of the invention, the electromagnetic pointer control method converts a moving distance of an electromagnetic pointer to a tip pressure thereof. As shown in FIG. 4, first of all, coordinates of an electromagnetic pointer after movement are calculated and obtained in step 402. A coordinate moving distance of the electromagnetic pointer is also calculated. Then, in step 404, the coordinate moving distance is sampled. Next, in step 406, an actual moving distance conversion is performed. Then, in step 408, an actual moving distance is calculated. Next, in step 410, a time and coordinate distance unit conversion is performed. Then, in step 412, a moving distance integration of the electromagnetic pointer is performed. Finally, a conversion of a tip pressure of the electromagnetic pointer is performed in step 414.

Coordinate calculation of an electromagnetic pointer

FIG. 5 shows a schematic diagram of a coordinate movement of an electromagnetic pointer. P is an initial location of the electromagnetic pointer while P̅ is a location of the electromagnetic pointer after movement. The coordinate moving distance is calculated according to the following equations. The coordinate of P,P=P(X, Y), and the coordinate of P̅, P̅= P̅( X̅, Y̅), the coordinate moving distance or displacement or length of line Lₜ is calculated by the following,

Lₜ=P(X,Y)− P̅( X̅, Y̅)

Lₜ=Lₜ(X− X̅,Y− Y̅)

X− X̅=Xₜ,Y− Y̅=Yₜ

Lₜ=Lₜ(Xₜ,Yₜ)

wherein Xₜ is the displacement of the electromagnetic pointer along x axis while Yₜ is the displacement of the electromagnetic pointer along y axis.

Sampling of the Coordinate Moving Distance of the Electromagnetic Pointer

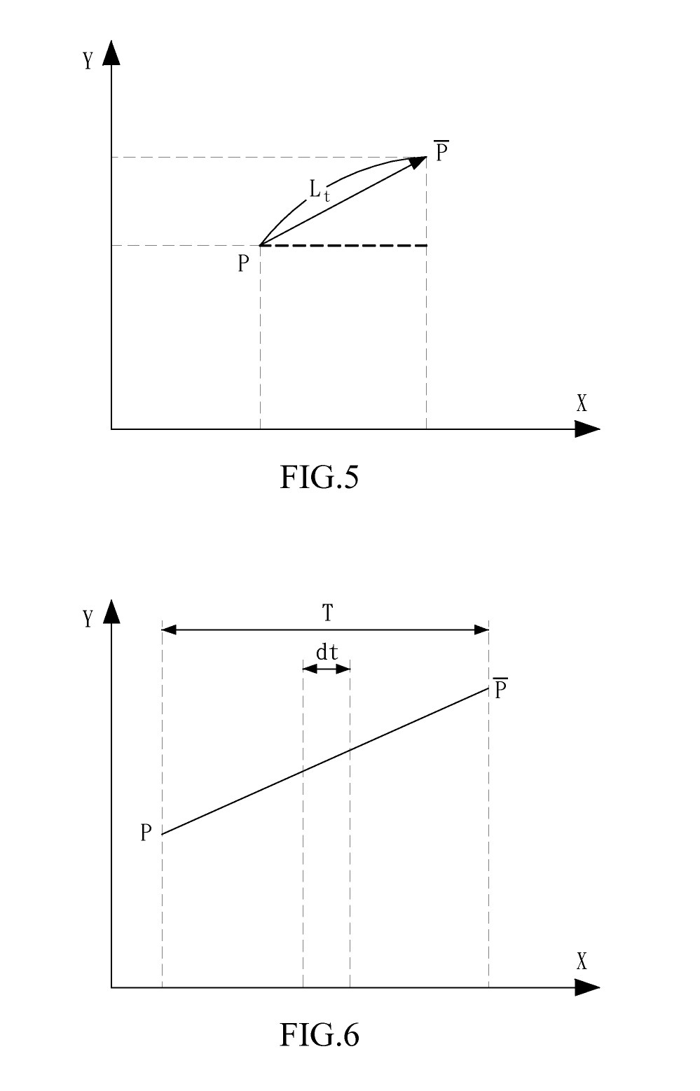

In one embodiment of the invention, the coordinate moving distance of the electromagnetic pointer is sampled and integrated in order to convert the coordinate moving distance to a tip pressure of the electromagnetic pointer. FIG. 6 shows a schematic diagram of sampling a coordinate moving distance of an electromagnetic pointer. A line displacement is obtained through differentiation according to the following equations, wherein ε is a length of displacement line, φ is a coordinate sampling length, P is an initial location of the electromagnetic pointer after differentiation, p̅ is an after-movement location of the electromagnetic pointer after differentiation, lₜ is a coordinate displacement after differentiation, xₜ is the displacement of the electromagnetic pointer along x axis after differentiation, and yₜ is the displacement of the electromagnetic pointer along y axis after differentiation. The length of displacement line ε of the electromagnetic pointer is calculated by:

$$∈ = {\{ [ \begin{matrix}{X}_{t} & 0 \\ 0 & {Y}_{t}\end{matrix} ] [ \begin{matrix}1 & 0 \\ 0 & 1\end{matrix} ] [ \begin{matrix}{X}_{t} \\ {Y}_{t}\end{matrix} ] \}}^{\frac{1}{2}} .$$

The coordinate displacement after differentiation lₜ is calculated by:

$$lt = \frac{d ∈}{d x}$$

$${l}_{t} = {\{ [ \begin{matrix}{X}_{t} & 0 \\ 0 & {Y}_{t}\end{matrix} ] [ \begin{matrix}1 & 0 \\ 0 & 1\end{matrix} ] [ \begin{matrix}{X}_{t} \\ {Y}_{t}\end{matrix} ] \}}^{\frac{1}{2}} [ \begin{matrix}\frac{d}{d x} \\ \frac{d}{d y}\end{matrix} ] .$$

Two new coordinates will be obtained after differentiation.

$${l}_{t} = p - \overline{p}$$

$${l}_{t} = p ( x , y ) - \overline{p} ( \overline{x} , \overline{y} )$$

$${l}_{t} = {l}_{t} ( x - \overline{x} , y - \overline{y} )$$

$$x - \overline{x} = {x}_{t} y - \overline{y} = {y}_{t}$$

$$δ = [ \begin{matrix}{x}_{t}^{′} & 0 \\ 0 & {y}_{t}^{′}\end{matrix} ] [ \begin{matrix}1 & 0 \\ 0 & 1\end{matrix} ] [ \begin{matrix}{x}_{t}^{′} \\ {y}_{t}^{′}\end{matrix} ] .$$

The coordinate sampling length is calculated by:

$$ϕ = {\{ [ \begin{matrix}{x}_{t}^{′} & 0 \\ 0 & {y}_{t}^{′}\end{matrix} ] [ \begin{matrix}1 & 0 \\ 0 & 1\end{matrix} ] [ \begin{matrix}{x}_{t}^{′} \\ {y}_{t}^{′}\end{matrix} ] \}}^{\frac{1}{2}} .$$

Conversion of an Actual Moving Distance

An actual moving distance m of an electromagnetic pointer can be calculated through the following equations, wherein μ is a unit of the actual moving distance, α is a predetermined unit transformation gain, R is a coordinate resolution, ε is a predetermined distance transformation unit,

$$ɛ = \frac{( μ \times α )}{R} .$$

The actual moving distance m is calculated by

m=ε×φ.

Time and Coordinate Distance Unit Conversion

T is an acceleration variation after a second differentiation, u is a time value of a second differentiation of the actual moving distance m

$$τ = \frac{d }{d u} m = \frac{d }{d u} ( ɛ \times ϕ ) .$$

Moving distance integration of the electromagnetic pointer

A moving distance M the electromagnetic pointer after integration is obtained by:

$$M = {\int }_{0}^{{T}_{{S}_{u \times h}}} τ d t ,$$

wherein T_{S} is an integration time, and h is a length of integration time. Further differentiation or integration can be performed according to requirement. The relation between time and distance can be changed to alter the requirement of time and distance.

### Conversion of a Tip Pressure of an Electromagnetic Pointer

In one embodiment of the invention, the tip pressure of an electromagnetic pointer is calculated according to the following equations,

$${pre}_{atten} = ( \frac{M * {pre}_{diff}}{{D}_{M}} )$$

$${pre}_{diff} = {pre}_{max} - {pre}_{min}$$

$$pre = {pre}_{max} - {pre}_{atten}$$

wherein preₘₐₓ is a maximum tip pressure of the electromagnetic pointer, preₘᵢₙ is a minimum tip pressure of the electromagnetic pointer, pre_{diff} is a tip pressure difference, preₐₜₜₑₙ is a tip pressure attenuation, D_{M} is a predetermined moving distance of the electromagnetic pointer, and pre is a tip pressure of the electromagnetic pointer. If the electromagnetic pointer is on an initial location or is static, the tip pressure pre of the electromagnetic pointer equals to a maximum tip pressure preₘₐₓ.

In another embodiment of the invention, the tip pressure pre of the electromagnetic pointer equals to a minimum tip pressure preₘᵢₙ when the electromagnetic pointer is on an initial location or is static, the tip pressure pre can be calculated by

pre=preₘᵢₙ+preₐₜₜₑₙ,

wherein preₐₜₜₑₙ is a tip pressure increase.

The embodiments of the invention can be applied on various electromagnetic pointers to perform various functions. Whether electromagnetic pointers are used to perform the embodiments of the invention depends on the requirements.

The electromagnetic pointer control method of the invention enables users to perform various functions of an electromagnetic pointer through converting coordinate movement signals generating from writing operation of the electromagnetic pointer to tip pressure gradient value signals by firmware or software programs when the electromagnetic pointer is applied on electromagnetic input apparatus or system.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. An electromagnetic pointer control method, comprising:
providing an electromagnetic pointer upon an electromagnetic input apparatus;
calculating a coordinate moving distance Lₜ of the electromagnetic pointer;
sampling and differentiating the coordinate moving distance Lₜ to obtain a coordinate displacement Iₜ, and calculating a coordinate sampling length φ by the coordinate displacement Iₜ;
calculating an actual moving distance m according to the coordinate sampling length φ, a unit μ of the actual moving distance, a predetermined unit transformation gain α and a coordinate resolution R;
differentiating the actual moving distance m to obtain an acceleration variation T;
integrating the acceleration variation T to obtain an integrated distance M; and
calculating a tip pressure of the electromagnetic pointer pre according to the integrated distance M, a predetermined maximum tip pressure preₘₐₓ, a predetermined minimum tip pressure preₘᵢₙ, and a predetermined moving distance D_{M}.

2. The electromagnetic pointer control method of claim 1, wherein the electromagnetic input apparatus comprises a digitizer.

3. The electromagnetic pointer control method of claim 1, wherein the electromagnetic input apparatus comprises an electromagnetic input module of a mobile communication apparatus.

4. The electromagnetic pointer control method of claim 1, wherein a predetermined distance transformation unit cis calculated by the following equation
$$ɛ = \frac{( μ \times α )}{R} .$$

5. The electromagnetic pointer control method of claim 4, wherein the actual moving distance m is calculated by the following equation
m=ε×φ.

6. The electromagnetic pointer control method of claim 1, wherein the tip pressure of the electromagnetic pointer pre is calculated by the following equations
$${pre}_{atten} = ( \frac{M * {pre}_{diff}}{{D}_{M}} )$$
$${pre}_{diff} = {pre}_{max} - {pre}_{min}$$
$$pre = {pre}_{max} - {pre}_{atten} .$$

7. The electromagnetic pointer control method of claim 1, wherein the tip pressure of the electromagnetic pointer pre is calculated by the following equations
$${pre}_{atten} = ( \frac{M * {pre}_{diff}}{{D}_{M}} )$$
$${pre}_{diff} = {pre}_{max} - {pre}_{min}$$
$$pre = {pre}_{max} + {pre}_{atten} .$$
